(19) United States
(12) Patent Application Publication
(10) Pub. No.: US 2024/0305028 A1
(43) Pub. Date: Sep. 12, 2024

(54) ELECTRICAL CONTACT ELEMENT FOR AN ELECTRICAL CONNECTOR WITH SURFACE TEXTURE AND METHOD OF SURFACE TREATMENT OF AN ELECTRICAL CONTACT ELEMENT

(71) Applicant: TE Connectivity Solutions GmbH, Schaffhausen (CH)

(72) Inventors: Felix GREINER, Bensheim (DE); Michael LEIDNER, Speyer (DE); Stefan THOSS, Bensheim (DE); Esteban SANCHEZ, Speyer (DE); Martin VIERT, Bensheim (DE); Matthias CASSEL, Speyer (DE); Helge SCHMIDT, Speyer (DE); Haythem KHILA, Speyer (DE)

(21) Appl. No.: 18/598,869

(22) Filed: Mar. 7, 2024

(30) Foreign Application Priority Data
Mar. 10, 2023 (DE) 102023106086.4

(51) Int. Cl. H01R 13/03; H01R 13/17; H01R 43/16

(52) U.S. Cl. CPC H01R 13/03; H01R 13/17; H01R 43/16

(57) ABSTRACT

An electrically conductive contact element for an electrical connector includes a connection region and a contact region. The contact region comprises a main region, an end region and a contact surface. The contact surface is arranged on at least one side surface of the main region and on at least one side surface of the end region. Caverns filled with an auxiliary material are arranged exclusively under the contact surface of the end region in a microstructure; and in the region of the microstructure, the contact surface has a surface texture. A method for enclosing an auxiliary material under a contact surface of the end region of a contact region of an electrically conductive contact element for an electrical connector is provided.

### CROSS REFERENCE TO RELATED APPLICATIONS

This application claims the benefit of German Application No. 102023106086.4 filed 10 Mar. 2023, the subject matter of which is herein incorporated by reference in its entirety.

### BACKGROUND OF THE INVENTION

The subject matter herein relates to electrically conductive contact elements and methods of manufacturing electrically conductive contact elements.

Electrical connectors and their contact elements are known in the state of the art in numerous designs. Electrical connectors are intended to be mated with a suitable mating connector in order to establish an electrical connection. Electrical connectors are generally used either for signal transmission or for power transmission and can be defined as an electromechanical system that provides a separable interface between two electronic subsystems. For this purpose, electrical connectors generally have electrically conductive contact elements that come into contact with a contact element of the mating connector when the connector is plugged together. The contact elements of one connector are often designed as contact pins and those of the mating connector as spring contacts. When the connector and mating connector are plugged together, the spring contacts exert elastic spring forces on the contact pins to ensure a reliable, electrically conductive connection.

Electrical connectors are used in motor vehicles, for example, to transmit power and network electrical and electronic systems. In motor vehicles, connectors are exposed to strong temperature fluctuations, vibrations and corrosive media. An increase in operating temperatures results in increased wear, particularly in the case of the widely used tin-plated copper-based contact elements. The most serious wear mechanism is fretting corrosion. This vibration wear caused by micro-vibrations leads to the formation of insulating oxide layers in contact areas and thus to the functional failure of connectors.

Base contact surfaces, e.g. with tin, nickel or their alloys, are particularly prone to frictional corrosion (fretting or seizing) in the event of small relative movements. Furthermore, the mating forces of high-pole connectors are often outside the values required by the customer. With precious contact surfaces, e.g. based on precious metals, the tendency to cold welding is a known problem.

In addition to high wear resistance, low mating and withdrawal forces are required to facilitate the assembly and maintenance of connectors.

In addition, during the mating of a connector with a mating connector, partial abrasion occurs on the contact surface of a contact element. This wear caused by abrasion limits the mating frequency of connectors and thus reduces their operating times.

In order to optimize the mating force, a microstructure is formed under the contact surface of the contact element in the connectors of the prior art and an auxiliary material is enclosed in this microstructure. When the connector is mated with a mating connector, the contact surface breaks open slightly and the auxiliary material emerges. In the state of the art, the entire contact surface of the contact element of the connector is structured. The leakage of the auxiliary material not only reduces the mating force, but the auxiliary material, which now adheres to the contact surface, can also lead to reduced electrical conductivity and therefore to a less stable electrical contact. In addition, it is only possible to structure the side facing the laser when manufacturing the contact elements and in particular when forming the microstructure using a laser. Depending on the connector type, this may not be the optimal side for reducing the mating force.

As the laser structuring process is an automated process, several contact elements are arranged a few millimeters apart on a carrier rail and structured one after the other using a laser. Due to this arrangement on the carrier rails, it is not possible to irradiate the sides facing a neighboring contact element, as the laser beams cannot reach them.

This means that only the side facing the laser can be irradiated and thus structured, which can lead to an insufficient reduction in the mating force.

There is therefore a need both for an improved contact element for a connector that minimizes the mating force while maintaining constant and long-lasting electrical performance, and for a method that enables the structuring of any side of the contact element.

### BRIEF DESCRIPTION OF THE INVENTION

In one embodiment, an electrical contact element is provided having a connection region and a contact region. The contact region comprises a main region, an end region and a contact surface for electrical contact with a mating contact element of a mating connector. The contact surface is arranged on at least one side of the main region and on at least one side of the end region, and caverns filled with an auxiliary material are arranged exclusively under the contact surface of the end region in a microstructure. In addition, the contact surface has a surface texture in sections in the region of the microstructure.

In an embodiment, the entire contact surface of a contact element does not have to be structured to achieve a lower mating force. The highest mating force must be overcome at the foremost section of a contact element, while the mating force contribution decreases along the length of the contact element. This means that it is sufficient to structure only a section of the contact element.

In an embodiment, the auxiliary materials are firmly embedded in the contact element, as they are filled in caverns that are arranged in a surface texture under the contact surface. This prevents the auxiliary material from being subject to negative effects, e.g. resignification. Undesirable loss of the auxiliary material is prevented by their solid embedding. In addition to liquid auxiliary materials, solid auxiliary materials can also be enclosed in the surface texture of the caverns in this way. In addition, the arrangement of the microstructure in the region where the mating force is highest, but where no electrical contact is made with a mating connector, ensures that the leaked auxiliary material does not affect the electrical performance.

An auxiliary material, also known as an additive, is a substance that is added in small quantities to achieve or improve certain properties.

A cavern is an artificially created cavity under the surface. The arrangement of the caverns below the contact surface means that the caverns do not have an outlet at the contact surface or, at most, an outlet that is so narrow that auxiliary material filled into the caverns cannot be reached without creating a breakthrough from the contact surface into the cavern.

According to an advantageous further development of the subject matter herein, the surface texture comprises elevations and recesses. The arrangement of the elevations and recesses results in the surface texture having a predetermined pattern of geometric elements.

Textured surfaces or a surface texture are surfaces with a deterministic pattern of geometric elements. The elements can have a high ratio of the depth or height of a structure to its lateral extent. Textured surfaces can have a periodicity in at least one direction. Examples of textures are elevations or recesses in the contact surface with circular, elliptical, square, linear or V-shaped cross-sections. A surface texture or textured surface reduces the contact area between the contact surface of the contact element and a contact surface of the mating connector when the connector and mating connector are mated. This reduces the frictional forces acting between the contact surfaces, which is advantageously accompanied by a reduction in the required mating forces. In addition, the contact points between the contact surfaces increase, so that a textured surface reduces the electrical contact resistance between the contact surface of the connector and the contact surface of the mating connector. A further advantage is that the abrasion of the contact surface is reduced by the texturing.

According to a further advantageous development of the subject matter herein, the microstructure forms a periodic structure, at least in sections. Such structures are easy to manufacture and have the advantage of reproducible properties. The periodic structure can, for example, form a line pattern, dot pattern, honeycomb pattern, cross pattern or the like.

A microstructure is a fine structure in the micrometer range. This is an essentially regular arrangement of certain elements, in this case the caverns. The spatial dimensions in the caverns are preferably in the range of 0.1-50 μm.

The microstructure can, for example, extend parallel to the contact surface and be arranged close to the surface. This ensures that during abrasion, openings are created from the contact surface into the caverns of the microstructure, so that the auxiliary materials escape from the caverns onto the contact surface and achieve the desired positive effects there.

According to a further advantageous development of the subject matter herein, a geometric element of the surface texture rises above a respective cavern of the microstructure. In this embodiment, the contact surface can be textured with knobs, in which knob caverns filled with auxiliary material are arranged. In this way, the advantages of a textured contact surface and a cavern microstructure with auxiliary materials under the contact surface can be realized in a particularly simple and space-saving manner. It is of course also possible to arrange the surface texture and the microstructure of the caverns alternately, i.e. offset to each other.

According to a further advantageous development of the subject matter herein, at least two side surfaces of the end region of the contact region taper in the insertion direction of the contact element along a longitudinal axis L. Advantageously, the at least two tapering side surfaces of the end region each have two converging edge contours which converge in such a way that each edge contour follows the course of a cubic function graph at least in sections, the course of the cubic function graph being dependent on the course of the longitudinal axis L.

According to a further advantageous development of the subject matter herein, the cubic function graph follows the equation y=(1−(x−x_o)\hat{ }3)*d/2 with x_0=total length of the main region and d=nominal thickness of the main region and wherein x follows the course of the longitudinal axis L.

The main part of the mating force when mating the connector with a mating connector must be applied to the end region of the contact region of the contact element. This end region must push the spring contacts of the mating contact element apart. As a result, an optimized shape and reduced mating force in this area are of particular importance. The advantageous design of the end region additionally reduces the mating force and the contact element is also insensitive to the geometry of the mating contact element.

According to a further advantageous development of the subject matter herein, the auxiliary material can be selected from the group of antioxidants, corrosion inhibitors, lubricants and acids. The auxiliary material can be a solid or liquid auxiliary material, for example an oil, grease, a paste or a solid lubricant such as graphite, carbon nanotubes (CNT), MoS2, AgS2 or a mixture of these substances.

A contact element according to the subject matter herein can be produced by means of a method for enclosing an auxiliary material under the contact surface of an end region of a contact region of an electrically conductive contact element for an electrical connector is provided, comprising the following steps: applying the auxiliary material to the contact surface of the end region, forming a microstructure on the contact surface of the end region, enclosing the auxiliary material in the caverns of the microstructure under the contact surface of the end region. A surface texture in the form of a prescribed pattern of geometric elements is formed on the contact surface of the end region and the contact surface of the end region is treated with laser radiation to form the microstructure. The laser radiation hits transversely to the contact surface of the end region and not perpendicular to the longitudinal axis L of the contact element.

In one embodiment of the method according to the subject matter herein, the laser radiation hits the contact surface of the end region at an angle β relative to the longitudinal axis L of the contact element, this angle β lying in a range between 0°<β<90°.

By forming the surface texture and the microstructure at the end region of the contact element, any side surface of the contact element can advantageously be treated using laser radiation. The laser beams can also treat side surfaces of the contact element which, when arranged on carrier rails, face the neighboring contact element.

The additional advantageous shape of the end region also means that although the laser beams do not hit the contact element perpendicular to the longitudinal axis L, the laser beams still hit the surface of the end region to be irradiated transversely, thus enabling uniform irradiation. Advantageously, microstructures can be formed over a large area in a precise and reproducible manner in a very short time using this type of irradiation.

In a particularly advantageous embodiment, the contact surface is treated with an interference pattern of laser radiation to form the microstructure. Two or more superimposed, preferably coherent and linearly polarized laser beams produce a selectively adjustable interference pattern. The intensity of the laser radiation is distributed within the interference pattern. In the case of positive interference, it increases and leads to particularly hot areas where the contact surface melts. At the intensity minimum, however, the contact surface is much colder, so that the contact surface does not melt or any auxiliary material present at this point remains present, while it evaporates in regions of positive interference. In addition, the high temperature gradients between the minimum temperature (in the area of negative interference) and the maximum temperature (in the area of positive interference) result in the convection of molten material on the contact surface and the formation of a texture. The texture is created when material on the contact surface is transported from areas of maximum temperature to areas of minimum temperature.

In a further embodiment of the method according to the subject matter herein, the auxiliary material can first be applied to the contact surface and then the microstructure can be formed. For example, the contact surface can first be coated with the auxiliary material, i.e. completely covered, which facilitates the application of the auxiliary material. When forming the microstructure, the auxiliary material is then applied to the areas where the caverns will later form, i.e. where it will be enclosed in the microstructure. For this purpose, the contact surface is treated with laser radiation.

According to one embodiment, the auxiliary material can be enclosed in the microstructure during the formation of the microstructure. According to this embodiment, the steps of forming the microstructure and enclosing the auxiliary material in the microstructure, i.e. in the cavern of the microstructure, take place in one step, which accelerates the method according to the subject matter herein.

For a better understanding of the present invention, it is explained in more detail with reference to the embodiments shown in the following figures. The same parts are provided with the same reference signs and the same component designations. Furthermore, some features or combinations of features from the different embodiments shown and described may represent independent inventive solutions or solutions according to the invention.

### BRIEF DESCRIPTION OF THE DRAWINGS

FIG. 1 is a schematic sectional view of the mating of a contact element with a mating contact element.

FIG. 2 is a schematic side view of a contact element according to an exemplary embodiment.

FIG. 3a is a schematic top view of the contact element according to an exemplary embodiment.

FIG. 3b is a schematic top view of the contact element according to an exemplary embodiment with R.

FIG. 4a is a schematic representation of the upper side of the contact element according to an exemplary embodiment.

FIG. 4b is a schematic representation of the side of the contact element according to an exemplary embodiment.

FIG. 5 is an enlarged schematic representation of the side of the contact element according to an exemplary embodiment.

FIG. 6a is a schematic representation of a further embodiment of the upper side of the contact element according to an exemplary embodiment.

FIG. 6b is a schematic representation of a further embodiment of the side of the contact element according to an exemplary embodiment.

FIG. 7a is a schematic representation of a further embodiment of the upper side of the contact element according to an exemplary embodiment.

FIG. 7b is a schematic representation of a further embodiment of the upper side of the contact element according to an exemplary embodiment.

FIG. 7c is a schematic representation of a further embodiment of the side of the contact element according to an exemplary embodiment.

FIG. 8 is a schematic representation of a further embodiment of the side of the contact element according to an exemplary embodiment.

FIGS. 9a, 9b and 9c are schematic representations of the surface treatment of the contact surface using a laser according to a method according to an exemplary embodiment.

FIG. 10 is a schematic sectional view of the contact surface after laser treatment according to the method of an exemplary embodiment.

FIG. 11 is a schematic representation of laser treatment according to the method of an exemplary embodiment.

FIG. 12 is a schematic representation of a further embodiment of a contact element according to an exemplary embodiment.

FIG. 13 is a schematic representation of the laser treatment of the further embodiment of a contact element according to an exemplary embodiment.

### DETAILED DESCRIPTION OF THE INVENTION

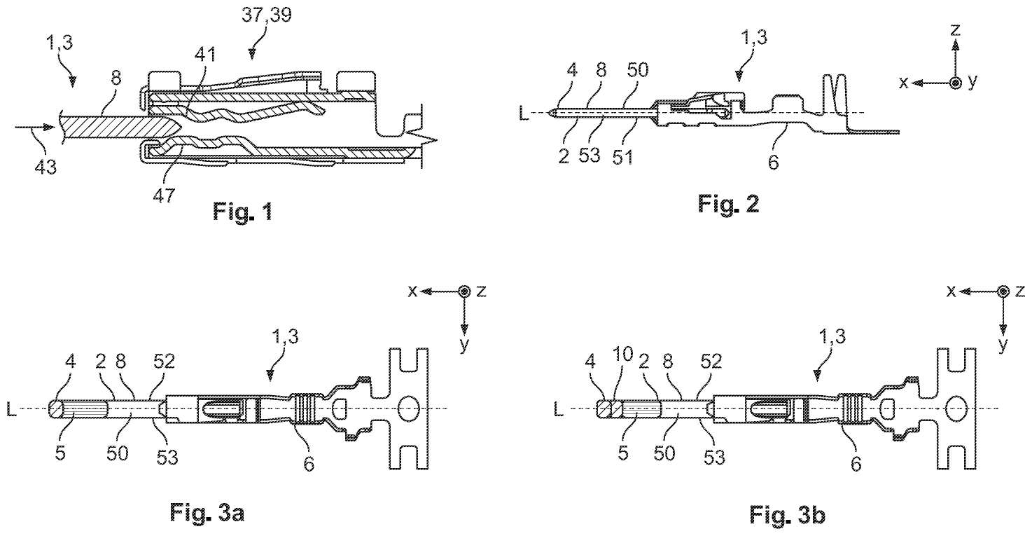

FIG. 1 schematically shows the mating of a contact element 1 of a connector 3 with a mating contact element 39 of a mating connector 37. During mating, the contact element 1 moves relative to the mating contact element 39 along a relative insertion direction 43. A contact region 8 of the contact element 1 is brought into contact with a mating contact region 41 of the mating contact element 39 by inserting the connector into the mating connector 37. In the process, the elastically deformable spring contacts 47 of the mating contact region 41 are pressed so far apart that the contact element 1 is held force-fit between the spring contacts 47. Due to the contact pressure exerted by the spring contacts 47 on a contact surface 5 of the contact region 8, frictional forces act between the contact surface 5 and the spring contacts 47, which must be overcome during the mating of the connector 3 with the mating connector 37. The force required to overcome the frictional forces, the so-called mating force, should advantageously be minimized by a configuration of the contact element 1 of the connector 3 according to the invention.

FIGS. 2, 3a and 3b show a contact element 1 of a connector 3 according to the invention from different perspectives. FIG. 2 shows a side view of the contact element 1, which has a connection region 6 for attaching required cables and a contact region 8 for establishing an electrical connection with the mating contact element 39. The contact region 8 comprises a main region 2 and an end region 4. The end region 4 is the part of the contact element 1 that first comes into contact with the mating contact element 39 when it is plugged together and is, for example, 1 mm in the embodiment shown. When the end region 4 comes into contact with the spring contacts 47 of the mating contact region 41, a first mating force must be overcome in order to push the spring contacts 47 apart. Only after the spring contacts 47 have been pushed apart for the first time the main region 2 comes into contact with the spring contacts 47. The spring contacts 47 continue to be pushed apart by the main region 2 until the desired mating position is reached. Consequently, it is clear that the highest mating force must be overcome when the end region 4 comes into contact with the spring contacts 47.

FIG. 3a shows a top view of the contact element 1 with the end region 4. As can be seen from FIGS. 2 and 3a, the contact element 1 extends in its length in the x-direction along a longitudinal axis L. The contact region 8 preferably comprises four side surfaces. An upper side 50, which is visible in the plan view in FIG. 3, extends in the x-y plane. The underside 51 of the contact region 8 is arranged parallel to this (FIG. 2). A first side 52 and a second side 53, each in the x-z plane, are located transverse to the upper- and undersides 50, 51. The electrical contact between the contact element 1 and the mating contact element 39 is established via a contact surface 5 on the contact region 8. The contact surface 5 can be arranged on any number of sides 50, 51, 52, 53 of the contact region 8, whereby it is advantageously arranged on at least one side surface of the main region 2 and on at least one side surface of the end region 4. Only the contact surface 5 of the end region 4 has a surface texture 31 in sections, and caverns 7 filled with an auxiliary material 9 are arranged under the contact surface 5 in the region of the surface texture 31. The caverns 7 are arranged in a microstructure 11 under the contact surface 5. In the embodiment shown, the contact surface 5 is arranged on the upper side 50, which extends in the xy plane. The upper- and undersides 50, 51 have a larger surface area than the first and second sides 52, 53, for example.

By arranging the microstructure and the surface texture only in the end region 4 of the contact region 8, the mating force is advantageously minimized while maintaining the same electrical performance. The leaked auxiliary material is distributed on the surface of the end region during mating, which means that a lower mating force is required to mate the two connectors 3, 37. At the same time, excessive auxiliary material is prevented from reaching the contact surface 5 of the main region 2. The electrical contact between the contact element 1 and the mating contact element 39 takes place at this point. This means that the electrical contact and a stable electrical connection are not affected by excess auxiliary material on the contact surface 5 of the main region 2.

FIG. 3 b shows a further exemplary embodiment of the contact region 8 of the contact element 1. Advantageously, an intermediate section 10 can be arranged between the end region 4 and the main region 2. In this advantageous embodiment, the intermediate section 10 consists of an electrically conductive material. Preferably, the intermediate section 10 is made of the same material as the main region 2. The end region 4 is advantageously made of a non-conductive material such as plastic. However, it is also possible that the end region 4 is also made of an electrically conductive material. In this embodiment, the contact surface 5 is preferably arranged on at least one side surface of the end region 4, on at least one side surface of the intermediate section 10 and on at least one side surface of the main region 2. The contact surface 5 of the end region 4 and the contact surface 5 of the intermediate section 10 have the surface texture 31 in sections and caverns 7 filled with an auxiliary material 9 are arranged under the contact surface 5 in the region of the surface texture 31. The caverns 7 are arranged in a microstructure 11 under the contact surface 5. This embodiment is used in particular for high-current connectors, such as those used for electromobility, where the reduction in mating force is of particular importance. The other advantageously mentioned features of the contact element are of course also applicable to this embodiment.

Advantageously, if the end region 4 is made of an electrically non-conductive material with a low melting temperature or softening temperature of, for example, 100 to 400° C., such as plastic, the electrically conductive coating 25 may not be provided, because the base material 13 can be formed in such a way that it forms caverns 7 with auxiliary material 9. However, an electrically non-conductive coating 25 can be applied to the end region 4, which is advantageous for forming the caverns 7 with enclosing of the auxiliary material 9.

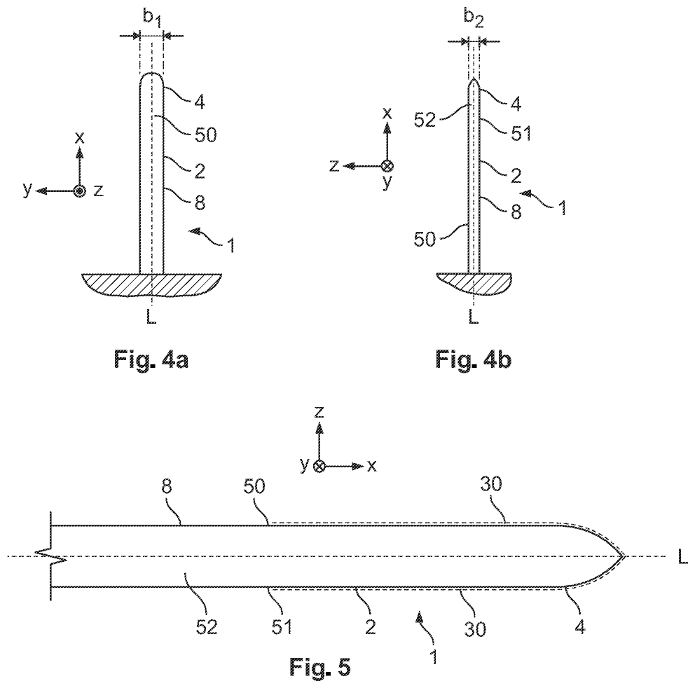

FIGS. 4-8 show various advantageous embodiments of the contact region 8 of the contact element 1. The orientation of the contact region 8 is defined in each case by the adjacent coordinate systems. FIG. 4 a shows a top view of the upper side 50 of the contact region 8 and FIG. 4 b shows a top view of the first side 52 of the contact region 8. According to an advantageous embodiment of the contact region 8, the upper- and undersides 50, 51 of the contact region 8 are textured, for example, and have the microstructure 11.

In addition, the side surfaces of the end region 4 taper along the longitudinal axis L in the insertion direction of the contact element 1. The underside 51 and the second side 53 of the contact region 8 correspond in shape to the upper side 50 and the first side 52. In the FIGS. 4 a and 4 b shown, the contact region 8 has an upper side 50 with a larger surface area than the first side 52. The end regions of the illustrated upper side 50 and first side 52 each have a different shape. Both shapes represent embodiments of the end region in accordance with the invention, on each of which the contact surface 5 can be arranged. In this case, a reduction in mating force is achieved both by the advantageous design of the edge contour 30 and by the advantageous design of the upper- and undersides 50, 51 of the end region 4 with texturing and microstructure.

The tapering of the side surfaces along the longitudinal axis L is shown in detail in FIG. 5 as an example for the first side 52. The first side 52 has an upper and a lower edge contour 30, whereby the terms “upper” and “lower” are defined along the z-axis in relation to the longitudinal axis L. The two edge contours 30 converge in such a way that each edge contour 30 follows the course of a cubic function graph, at least in sections. The course of the cubic function graph depends on the course of the longitudinal axis L. Thus, for example, the upper edge contour 30 follows a cubic function graph along the longitudinal axis L. The same applies to the lower edge contour 30.

Furthermore, the course of the cubic function graph of the upper and lower edge contour 30 of the first side 52 shown in FIG. 5 follows the equation:

$$y = ( 1 - ( x - x\_o ) \hat{} 3 ) * d / 2 , \qquad ( 1 )$$

with x_0=total length of the main region 2, d=nominal thickness of the main region 2 and where x follows the course of the longitudinal axis L. The length x_0 refers to the origin of the coordinates. From the x_0 coordinate, the edge contours 30 each advantageously follow the course of equation (1). This advantageous shape of the two edge contours of the end region minimizes the required mating force when mating the connector 3 with a mating connector 37. However, it is clear that the two edge contours can also deviate from the above-mentioned equation (1) and a reduced mating force can still be achieved. It is also clear that the embodiment of the first side 52 described in detail also applies to the second side 53.

However, it is clearly understood that in a further advantageous embodiment, it is also possible that the side surfaces of the end region 4 having the edge contours following equation (1) are textured and have the microstructure 11. Consequently, any side surface may have these advantageous features in combination or individually.

For example, the upper- and undersides 50, 51 in this embodiment have a width b1 of 1.2 mm, and the first and second sides 52, 53 have a width b2 of 0.6 mm. However, the embodiment is not limited to this size, but any connector widths can be realized depending on the area of application. Advantageously, the connector width b1 is in a range from 0.3 mm to 12 mm and the connector width b2 is in a range from 0.3 mm to 2 mm.

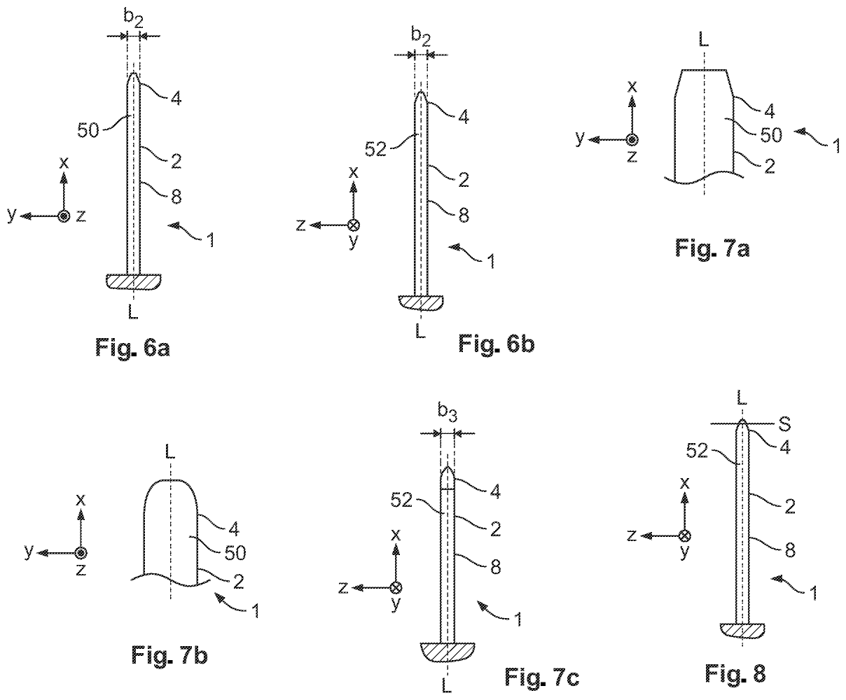

A further advantageous embodiment of the contact region 8 is shown in FIG. 6. FIG. 6 a shows a top view of the upper side 50 of the contact region 8 and FIG. 6 b shows a top view of the first side 52 of the contact region 8. In this embodiment, all side surfaces 50, 51, 52, 53 correspond to equation (1). In particular, the contact region 8 in this advantageous embodiment has a contact surface 5 on all side surfaces 50, 51, 52, 53 of the end region, which has a surface texture and under which caverns filled with auxiliary material are arranged. This embodiment is particularly suitable for square plugs, in which a contact surface is arranged on all four side faces 50, 51, 52, 53. For example, the width b2 of the contact region 8 is 0.63 mm for both the upper and undersides 50, 51 and also for the first and second sides 52, 53. However, it can be seen that other dimensions for the side surfaces are also within the meaning of this embodiment.

It is clear that the embodiments shown for the upper side 50 and the first side 52 also apply accordingly to the underside 51 and the second side 53.

FIG. 7 shows further advantageous embodiments of the upper side 50 and the first side 52 of the contact region 8. FIG. 7 a and b show two advantageous embodiments of the upper side 50 of the contact region 8. The respective end region 4 is formed differently. FIG. 7 c shows a further advantageous embodiment of the first side 52 of the contact region 8. The first side 52 has a larger surface area than the embodiment shown in FIG. 6 b. For example, the side surfaces 52, 53 have a width b3 of 0.8 mm.

FIG. 8 shows a further advantageous embodiment of the first side 52 of the contact region 8, in which it is indicated that the end region 4 is cut off. A cut line S in FIG. 8 indicates that the tip of the end region 4 can be cut off without the connector deviating from the scope of the invention and that the positively mentioned effects of the invention are nevertheless achieved.

The different embodiments are used for different connector types with different contact areas. It is intended to illustrate that the contact element according to the invention and the method according to the invention can be used for a variety of different connector types and is therefore not limited to a specific type of connector.

The method according to the invention for enclosing an auxiliary material 9 under the contact surface 5 of the end region 4 of the contact region 8 of the contact element 1 is explained below. It is clear that the method described below can also be used to enclose auxiliary material in contact elements with end region 4 and intermediate section 10.

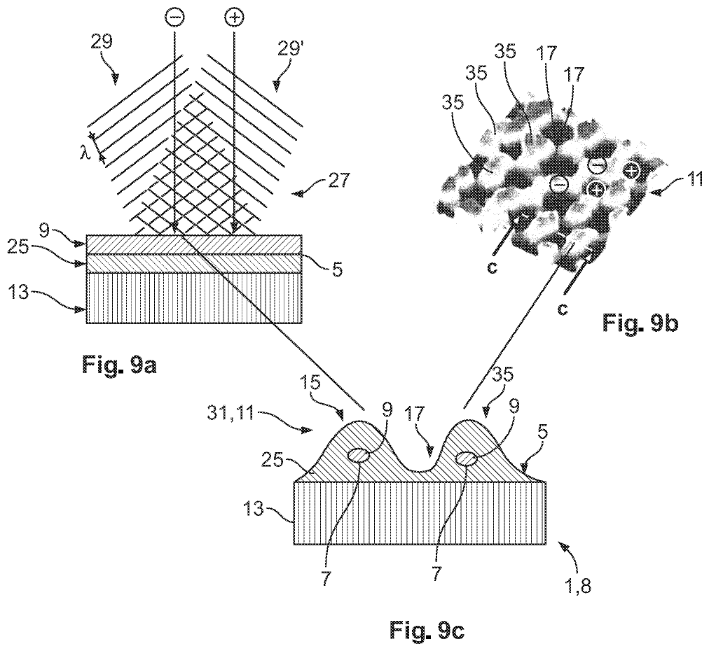

FIGS. 9a, 9b and 9c show a method according to the invention for enclosing the auxiliary material 9 under the contact surface 5. The starting material of the method according to the invention is the contact region 8 of a contact element 1 of a connector 3, wherein the contact region 8 comprises a main region 2, an end region 4 and a contact surface 5 for mechanical and electrical contact with a mating contact element 39 of a mating connector 37. The main region 2 is electrically conductive and consists of a base material 13. The base material 13 can be copper or a copper alloy, for example. In addition, as shown in FIG. 9a, for example, a coating 25 may have been applied to a surface of the base material 13. The coating 25 may, for example, comprise tin, nickel, silver or alloys of tin, nickel, silver and/or other elements. The coating 25 may, for example, have been applied to the base material 13 by hot-dip tinning or electroplating, whereby further intermediate layers are possible. A surface of the coating 25 facing away from the base material forms the contact surface 5. The end region 4 can also be electrically conductive and the same applies as for the main region 2. If the end region 4 is made of an electrically non-conductive material with a low melting temperature or softening temperature of e.g. 100 to 400° C., for example plastic, an electrically conductive coating 25 is advantageously not provided, because the base material 13 can be formed in such a way that it forms caverns 7 with auxiliary material 9. However, an electrically non-conductive coating 25 can be applied to the end region 4, which is advantageous for forming the caverns 7 with inclusion of the auxiliary material 9.

First, the auxiliary material 9 is applied to the contact surface 5. For example, the contact surface 5 can be completely coated with the auxiliary material 9, as shown in FIG. 9 a, for example. The auxiliary material 9 can be oil, grease, a paste or a solid lubricant such as graphite, CNT, MoS2, AgS2 or mixtures thereof.

After the auxiliary material 9 has been applied to the contact surface 5, the microstructure 11 is then formed. In the exemplary process shown, the auxiliary material 9 is enclosed in the microstructure 11 during the formation of the microstructure 11. For this purpose, the contact surface is treated with an interference pattern 27 by laser radiation 29, 29′. Advantageously, very large contact surfaces can be microstructured within a very short time by using a laser.

In the embodiment shown, for example, the microstructure 11 consists of periodically alternating elevations 15 and recesses 17, with the recesses 17 forming trenches and the elevations forming ramparts in between. This results in a regular periodic strip structure as microstructure 11 with a period length p.

In laser interference texturing, two or more superimposed, preferably coherent or linearly polarized laser beams 29, 29′ produce a specifically adjustable interference pattern 27. A prerequisite for this is the spatial and temporal coherence of the laser beams 29, 29′. The spatial coherence can be impaired by interaction with the environment or the optical elements of the apparatus for generating the interference radiation. The temporal coherence depends on the spectral bandwidth of the laser radiation 29, 29′. Common coherence lengths of the spectral bandwidth are in the range from 266 to 1064 nm.

Different interference patterns 27, for example line patterns, dot patterns, honeycomb patterns, cross patterns, etc., can be generated by selecting the laser radiation and the number and alignment of the laser beams in relation to each other. The interference pattern 27 defines the microstructure 11 and the surface textures 31 of the contact surface 5 of the end region 4.

If the contact surface 5 of the end region 4 is treated with an interference pattern 27 consisting of laser radiation 29 and 29′, two or more superimposed, coherent and linearly polarized laser beams 29 and 29′ produce a specifically adjustable interference pattern 27. The intensity of the laser radiation is distributed within the interference pattern 27. In the case of positive interference (+), it increases and leads to particularly hot areas where the contact surface 5 of the end region 4 melts. In the intensity minimum with negative interference (−), on the other hand, the contact surface 5 of the end region 4 is much colder, so that the contact surface 5 of the end region 4 does not melt or rather the auxiliary material 9 located at this point remains present, while it evaporates in regions of positive interference. In addition, the high temperature gradients between the minimum temperature (in the region of negative interference) and the maximum temperature (in the region of positive interference) result in the convection of molten material of the contact surface 5 of the end region 4 and the formation of a texture 31. The texture 31 is created by the fact that material of the contact surface 5 of the end region 4 is transported from regions of maximum temperature to regions of minimum temperature.

If the contact surface 5 of the end region 4 of an electrically conductive contact region 8, to which a layer of an auxiliary material 9 has been applied, is irradiated with an interference pattern 27 consisting of laser radiation 29 and 29′ (FIG. 9 a), the following occurs: In the region of positive interference (+), the auxiliary material 9 evaporates and volatilizes, while in the region of negative interference (−) it remains on the contact surface 5 of the end region 4. Furthermore, the material of the contact surface 5 of the end region 4 melts in areas of positive interference and spills in a directed manner into the areas of negative interference, where, forming elevations 15, it covers the auxiliary material 9 remaining there. In this way, the contact surface 5 of the end region 4 can be formed as shown in FIGS. 9 b and 9 c, which has a knob structure 33, each knob 33 having a cavity 7 filled with auxiliary material.

During interference texturing, the auxiliary material 9 is therefore enclosed in the microstructure 11 when the microstructure 11 is formed. At the same time, texturing 31 of the contact surface 5 of the end region 4 takes place. In the embodiment shown, the surface texture 31 is formed by a knob structure 33 with regularly arranged knobs 35 and recesses 17 in between. In the embodiment example shown, the surface texture 31, i.e. the knob structure 33, is congruent with the microstructure 11 of the caverns 7, which are filled with auxiliary materials 9. The surface texture 31 rises above a cavern 7 of the microstructure 11. In the example shown, a cavern 7 filled with auxiliary materials 9 is arranged in each knob 35.

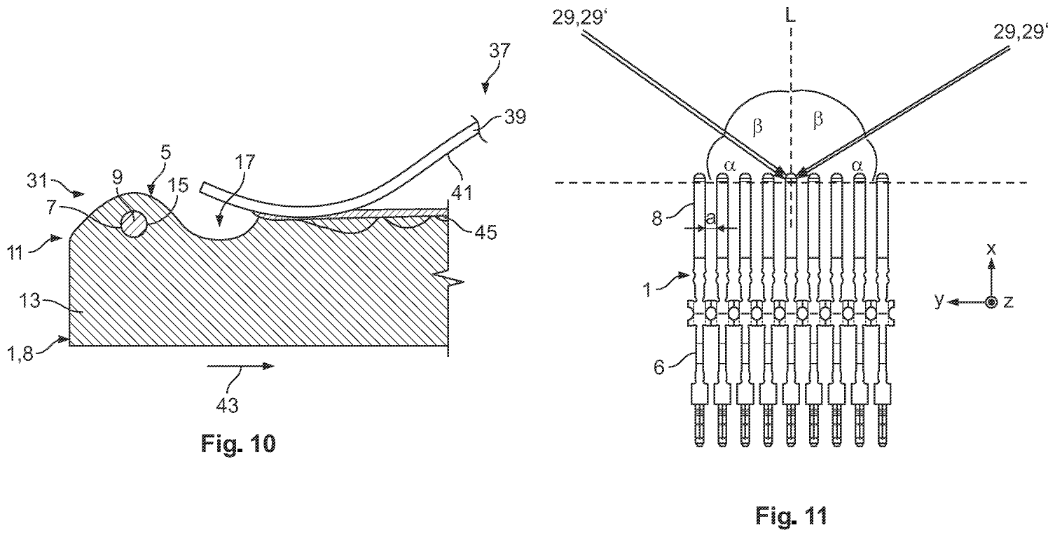

In FIG. 10, parts of a contact element 1 according to the invention with an electrically conductive contact region 8 are shown in schematized and partially sectioned representation when plugged together with a mating contact element 39.

The contact region 8 is designed as a contact pin, for example, and is shown in section. The contact region 8 is electrically conductive and consists of a base material 13, for example copper or copper alloy. The contact region 8 has a contact surface 5. Caverns 7 filled with an auxiliary material 9 are arranged in a microstructure 11 under the contact surface 5. The contact surface 5 in the embodiment shown has a surface texture 31 consisting of periodically alternating elevations 15 and recesses 17. A cavern 7 of the microstructure 11 filled with auxiliary material 9 is arranged in each elevation 15. The surface texture 31 and the microstructure 11 of the contact region 8 of FIG. 10 thus essentially correspond to those of FIG. 9, with the exception that the coating 25 has been omitted and the auxiliary material 9 has been applied directly to the base material 13.

FIG. 10 also shows a part of a mating contact element 39 of a mating connector 37. The mating connector 37 is intended to be plugged together with the connector 3. The mating contact element 39 has a mating contact region 41, which comes into contact with the contact region 8 of the contact element 1 when the connector 3 is mated with the mating connector 37. The mating contact region 41 is designed as an elastically deformable spring contact.

If the connector 3 and the mating connector 37 are plugged together as shown in FIG. 10, a further contact surface of the mating contact region 41 touches the contact surface 5 of the contact region 8 in order to establish an electrically conductive connection. During the mating of the connector 3 with the mating connector 37, the contact element 1 moves relative to the mating contact element 39 along a relative insertion direction 43.

Due to the contact pressure exerted by the mating contact region 41 of the mating contact element 39 on the contact region 8 of the contact element 1, frictional forces act between the contact surface 5 and the other contact surface of the mating contact region 41, which must be overcome during the mating of the connector 3 with the mating connector 37. In order to reduce these forces, the contact surface 5 is provided with a surface texture 31. In addition, the surface texture 31 and the microstructure 11 of the end region 4 of the contact region 8 are partially broken up during mating. The frictional forces create access to the closed caverns 7 previously located under the contact surface 5. The caverns 7 open towards the contact surface 5. The auxiliary material 9 can escape from the cavern 7 and form a film 45 of auxiliary material 9 on the contact surface 5, which has the desired positive effect, for example a reduction in friction and corrosion protection.

FIG. 11 schematically shows the position and orientation of the laser in relation to the contact element 1 during laser interference texturing. A large number of contact elements 1 are arranged close to each other as an example. The figure shows an exemplary top view of the plurality of contact elements 1. Such an arrangement of contact elements 1 fixed on one side to carrier rails is used in order to be able to treat a large number of contact elements as quickly and efficiently as possible in an automated process using a laser. The distance a between two neighboring contact elements 1 can be 1.2 mm, for example.

Consequently, it is clear that with such an arrangement, laser treatment of the main region 2 of the contact region 8 is only possible to a limited extent. Only one side facing the laser can be treated using laser radiation. It is therefore almost impossible to treat the side of the main region 2 facing a neighboring contact element 1.

In the method according to the invention, advantageously only the end region 4 of the contact region 8 is treated by means of laser radiation. Thus, the method according to the invention can be used to treat contact elements 1 closely arranged on a carrier rail simply and cost-effectively by means of laser radiation.

As shown in FIG. 11, the laser radiation hits transversely to the contact surface 5 of the end region 4. This achieves a uniform surface treatment in the desired region. However, the laser radiation does not hit perpendicular to a longitudinal axis L of the contact element 3. This axis extends along the entire length of the contact element. In particular, an angle β between the longitudinal axis L of the contact element 1 to be treated and the laser radiation is in a range of 0°<β<90°.

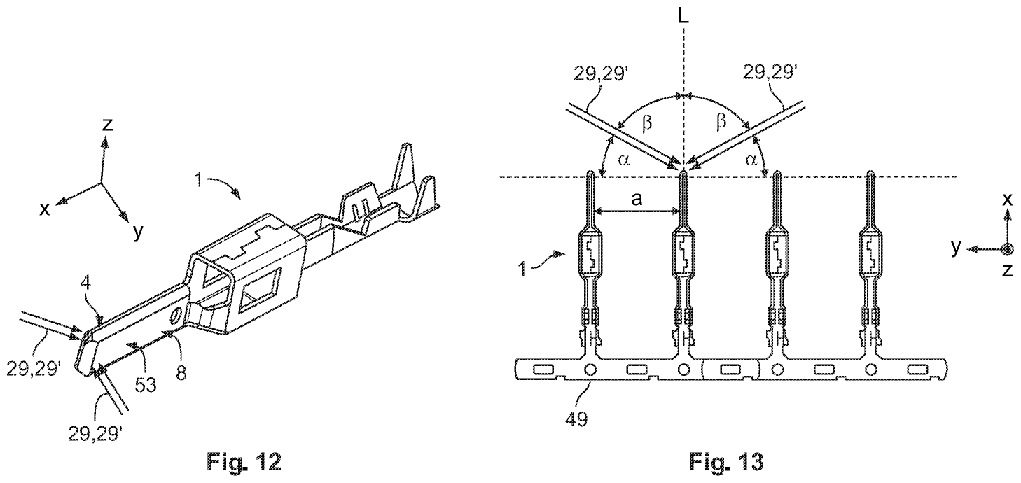

FIG. 12 shows another exemplary embodiment of a contact element 1. In this embodiment, the contact region 8 has sides 52, 53 that are larger in area than the upper- and undersides 50, 51. The left and right sides 52, 53 also extend in the xz plane in this embodiment, and the upper- and undersides 50, 51 extend in the xy plane. As an example, the surface to be textured of the end region 4 of the contact region 8 is arranged on the sides 52, 53.

As shown in FIG. 13, the method according to the invention enables the surface treatment by means of laser radiation 29, 29′ of contact elements 1 which are attached to a carrier rail 49 and whose side surfaces 52, 53 are to be treated. As previously mentioned, the distance a between two contact elements 1 arranged adjacent to each other on the carrier rail 49 is too small to texture the entire side surfaces.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Electrically conductive contact element for an electrical connector comprising:
a connection region and a contact region;
wherein the contact region comprises a main region, an end region, and a contact surface for electrical contact with a mating contact element of a mating connector;
wherein the contact surface is arranged on at least one side surface of the main region and on at least one side surface of the end region, and
wherein caverns filled with an auxiliary material are arranged exclusively under the contact surface of the end region in a microstructure; and
wherein the contact surface has a surface texture in sections in the region of the microstructure.

2. The electrically conductive contact element according to claim 1, wherein
the surface texture comprises elevations and recesses.

3. The electrically conductive contact element according to claim 1, wherein the surface texture comprises a predetermined pattern of geometric elements.

4. The electrically conductive contact element according to claim 1, wherein the microstructure forms a periodic structure at least in sections.

5. The electrically conductive contact element according to claim 1, wherein a geometric element of the surface texture rises above a respective cavern of the microstructure.

6. The electrically conductive contact element according to claim 1, wherein at least two side surfaces of the end region of the contact region taper in the insertion direction of the contact element along a longitudinal axis (L).

7. The electrically conductive contact element according to claim 6, wherein the at least two tapering side surfaces of the end region each have two converging edge contours which converge in such a way that each edge contour follows the course of a cubic function graph at least in sections,
wherein the course of the cubic function graph depends on the course of the longitudinal axis (L).

8. The electrically conductive contact element according to claim 7, wherein the cubic function graph follows the equation y=(1−(x−xₒ)³)*d/2 with x₀=total length of the main region and d=nominal thickness of the main region and wherein x follows the course of the longitudinal axis L.

9. The electrically conductive contact element according to claim 1, wherein the auxiliary material is selected from a group of antioxidants, corrosion inhibitors, lubricants and acids.

10. An electrical connector comprising
an electrical contact element including a connection region and a contact region;
wherein the contact region comprises a main region, an end region, and a contact surface for electrical contact with a mating contact element of a mating connector;
wherein the contact surface is arranged on at least one side surface of the main region and on at least one side surface of the end region, and
wherein caverns filled with an auxiliary material are arranged exclusively under the contact surface of the end region in a microstructure; and
wherein the contact surface has a surface texture in sections in the region of the microstructure.

11. A method for manufacturing an electrically conductive contact element for an electrical connector having an auxiliary material enclosed under a contact surface of an end region of a contact region of the contact element comprising the steps of:
applying the auxiliary material to the contact surface of the end region,
forming a microstructure on the contact surface of the end region,
final enclosing of the auxiliary material in caverns of the microstructure under the contact surface of the end region,
wherein a surface texture in the form of a predetermined pattern of geometric elements is formed on the contact surface of the end region, and
wherein the contact surface of the end region is treated with laser radiation to form the microstructure, and
wherein the laser radiation hits transversely to the contact surface of the end region,
wherein the laser radiation does not hit perpendicular to the longitudinal axis (L) of the connector.

12. The method according to claim 11, wherein the laser radiation hits on the contact surface of the end region at an angle β relative to the longitudinal axis (L) of the contact element,
wherein the angle β lies in a range between 0°<β<90°.

13. The method according to claim 11, wherein the contact surface is treated with an interference pattern of laser radiation to form the microstructure.

14. The method according to claim 11, wherein first the auxiliary material is applied to the contact surface and subsequently the microstructure is formed.

15. The method according to claim 11, wherein the auxiliary material is enclosed in the caverns of the microstructure when the microstructure is formed under the contact surface.
